(19) United States
(12) Patent Application Publication
(10) Pub. No.: US 2003/0161387 A1
(43) Pub. Date: Aug. 28, 2003

(54) Cdma radiocommunication method with access codes and corresponding receiver

(76) Inventors: Laurent Ouvry, Le Versoud (FR); Julien Barletta, Grenoble (FR); Mathieu Bourvier Des Noes, Grenoble (FR); Didier Lattard, Rencurel (FR)

Correspondence Address: Robert E Krebs, Thelen Reid & Priest, P O Box 640640, San Jose, CA, 95164-0640, US

(21) Appl. No.: 10/182,494

(22) PCT Filed: Jan. 30, 2001
(86) PCT No.: PCT/FR01/00284

(30) Foreign Application Priority Data
Jan. 31, 2000 (FR) 00/01184

(51) Int. Cl. H04K 1/00

(52) U.S. Cl. 375/142

(57) ABSTRACT

CDMA radio-communications procedure with access codes and pertinent receiver.

According to the invention, the access is performed through some access codes or some correlators. The receiver also includes some means for correcting the interference arising between the access codes and the traffic codes. These means may be formed by a high-pass filter.

Application for radio-communications, especially in satellite telephony, etc . . .

### TECHNICAL FIELD

The present invention has as its purpose a CDMA (Code Division Multiple Access) radio-communications procedure using access codes and a pertinent receiver.

It has an application in telecommunications, especially in geostationary satellite telephony, on wired networks, on a wireless local loop, etc. . . .

### PREVIOUS STATE OF THE ART

The procedure in the invention uses the Direct Sequence Spread Spectrum technique (abbreviated as DSSS). DSSS consists of modulating each symbol in the digital signal to be transmitted by a pseudo-random bit sequence (PRBS). Such a sequence is made up by N impulses or “chips” whose duration Tc is equal to Ts/N, where Ts is the duration of the symbol. The modulated signal has a spectrum which is spread across a range N times larger than that of the original signal. Upon reception, the demodulation consists of correlating the signal with the sequence used upon transmission, which allows the information linked to the output symbol to be found. This technique allows multiple access by assigning different sequences to different users. Thus, the CDMA technique consists of the simultaneous transmission, in the same band, of several spread signals using different pseudo-random spread sequences. The sequences are chosen in such a way that the intercorrelations will remain low.

One of the problems posed by this technique is how to allow new users to access the network, when the latter is already occupied by some users who are communicating. In particular, it is interesting to have some users who are communicating and some users who are accessing in the same waveband simultaneously. One of the techniques used, described for example in the document WO 97/08861, consists of interrupting the transmission of traffic signals for certain time slots and to use these slots for processing the access requests.

This solution is hardly satisfactory because it cuts down the system's overall capacity. In effect, in certain cases, some time slots reserved for the newcomers remain empty. The present invention is precisely aimed at solving this drawback.

### OVERVIEW OF THE INVENTION

For this purpose, the invention proposes a procedure that does not require the interruption of the communications. A priori, therefore there is no longer any drop in the system's capacity. This aim is achieved by the use of codes specially assigned to the access, in concomitance with the codes assigned to the information (traffic codes) or to different commands.

More precisely, the present invention has as its aim a CDMA, Code Division Multiple Access, type radio-communications procedure in which:

codes called traffic codes are used formed by sequences of impulses having a certain rate, with these codes belonging to the different users in the system; the codes are modulated by the information that each user must transmit and the modulated codes are transmitted,

the signal corresponding to all the signals transmitted is received, a correlation is performed adapted to the different codes, the correlation signal is demodulated and the information transmitted is recovered,

with this procedure being characterised by the fact that, in order to allow a new user to use the procedure:

a predetermined specific code is transmitted, called an access code, belonging to this new user, with this code being formed by a sequence of pulses having the same rate as the sequences of the traffic codes, with this access code being modulated by a particular series of symbols,

the possible presence of these predetermined access codes is scanned for in the signal received and, in the event of the presence of such a code, the user is identified and he is authorised to communicate.

The access code is not a prior synchronised with the traffic codes.

Preferentially:

when transmitting, the modulation for the data transfer is Quaternary Phase Shift Keying (QPSK), with the modulated signal having two components (I, Q), of which one (I) is in phase with a carrier and the other (Q) is in quadrature phase with the carrier,

upon reception, the correlation is performed on two components (I, Q) respectively in phase and in quadrature phase and two corresponding correlation signals are produced.

Preferentially again, in this variation:

when transmitting, the access codes are modulated by a series of symbols whose phases are spread out between one another by k.90°, where k is equal to 0, 1, 2 or 3,

upon reception, in order to search for the presence of an access code, a combined delayed multiplication is carried out on two correlation signals in order to obtain a complex signal having one real component and one imaginary component, and the presence of a positive or negative peak is searched for, over a duration equal to the duration of a symbol, in at least one of the real and imaginary components.

The presence of these additional pseudo-random sequences linked to the access codes may lead to a disruption in the sequences linked to the traffic by some noise phenomena between codes. The present invention envisages therefore that each correlation signal corresponding to a traffic code will be corrected in order to take into account the noise between this traffic code and the set of access codes present.

The present invention also has as its purpose a CDMA type receiver whose basic characteristic is that of including the appropriate means for detecting the presence of access codes in the reception signal.

### BRIEF DESCRIPTION OF THE DRAWINGS

FIG. 1 is a simplified timing chart showing the spread of the traffic codes and the access codes;

FIG. 2 illustrates a first mode for producing the means to detect the access codes;

FIG. 3 illustrates a second mode for producing the means to detect the access codes;

FIG. 4 shows the general curve of the filtered signal linked to the accesses;

FIG. 5 shows the source of different noise between codes;

FIG. 6 shows the spread of the constellation of the signals because of the presence of access codes;

FIG. 7 illustrates in a schematic form a receiver with correction of the noise due to the access codes through high-pass filtering;

FIG. 8 illustrates a specific mode for producing the high-pass filter;

FIG. 9 shows a combined delayed multiplication circuit;

FIG. 10 illustrates a mode for implementation with 4 tests on 4 types of access codes.

### DESCRIPTION OF SPECIFIC MODES OF IMPLEMENTATION

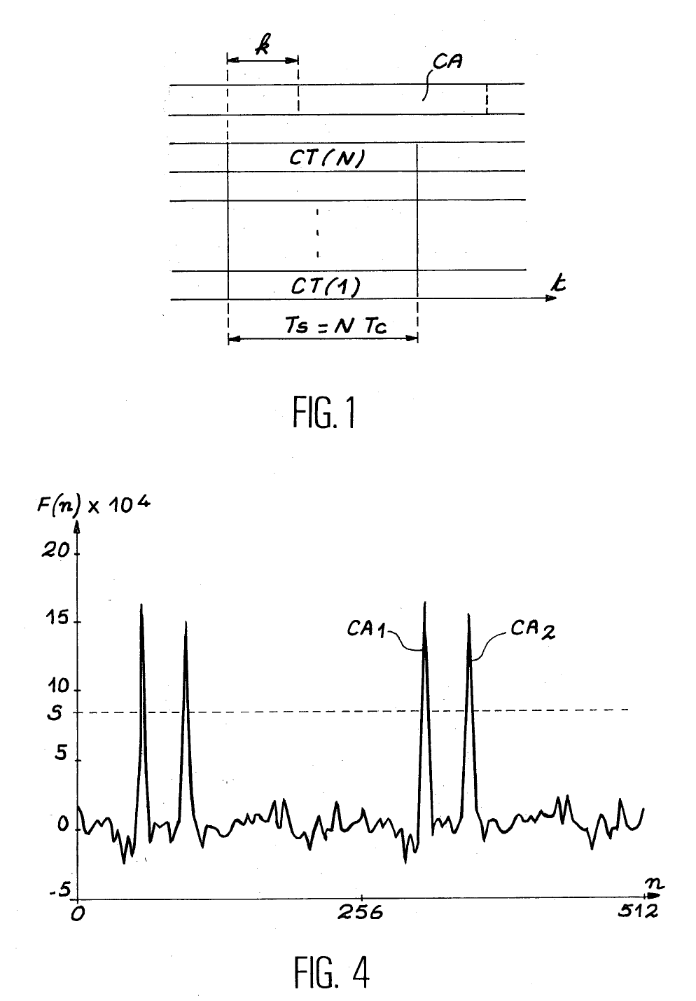

FIG. 1 is a timing chart showing, in a schematic format, in a period a symbol with a duration Ts, a plurality of traffic codes CT(1), . . . , CT(N) allocated to N users and an access code CA, not necessarily synchronised with the traffic codes, but spread from kTc where Tc is the duration of an impulse from the sequence (“chip”) with 0<k<N−1. This access code may have, by itself, a length of NTc as well, but not necessarily.

All these codes are transmitted concomitantly, with the difference being that the traffic codes carry information (including, amongst others, the data to be transmitted) whereas the access codes do not carry any data as such. From the electronics point of view, that means that the traffic codes are modulated by the data to be transmitted whilst the access codes are not.

The receiver must be suitable for detecting the traffic codes and to process them, which is well known by an expert in this field, but also suitable for detecting the access codes, which is part of the invention. Only the means relating to the processing of the access codes shall be described as follows, since the means for processing the traffic codes are widely known. It is simply reminded here that they use some adapted filters and/or some correlators, some demodulaters, some decision circuits and some means for recovering the clock signal.

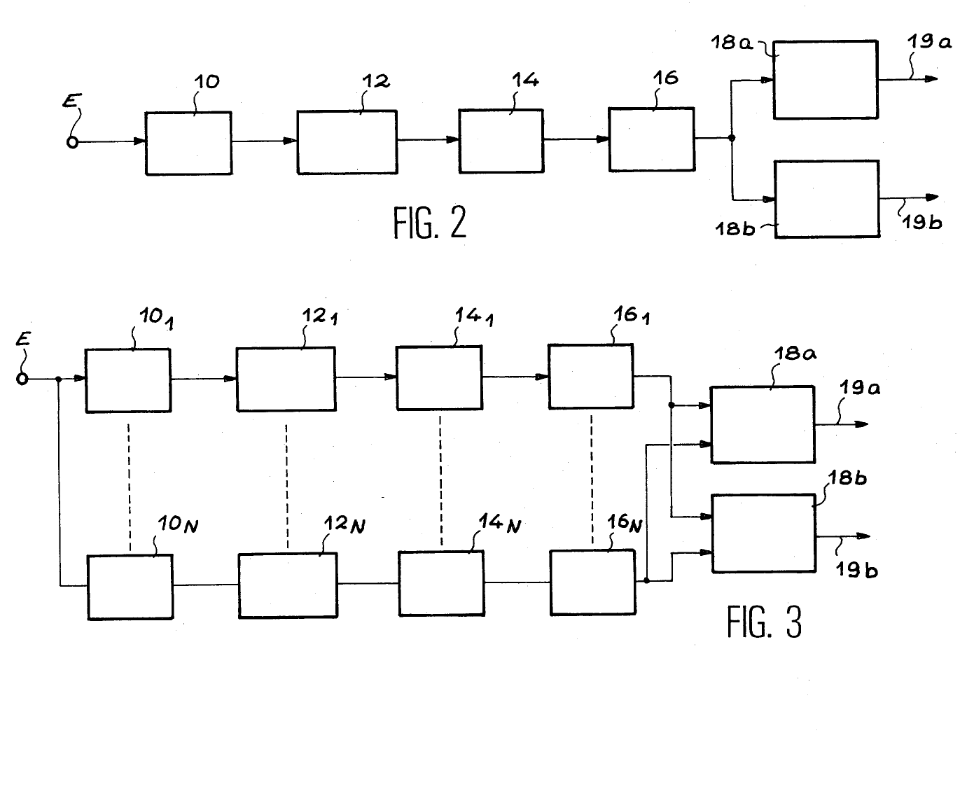

Since some means for processing the access codes are involved, two specific modes for implementation are illustrated in FIGS. 2 and 3:

The means shown in FIG. 2 include:

a general input E,

a filter 10 adapted to the access code,

a means 12 for performing a combined delayed multiplication,

a circuit 14 for extracting the real component (or part) of the signal delivered by the previous means, a digital filter 16,

some means 18a for detecting the overshoot of a predetermined threshold by the filtered signal, and some means 18b for counting the number of overshoots in a time window with a duration equal to the duration Ts of the data symbols transmitted; these two means have some outputs 19a and 19b.

In order to understand the functioning of this form of processing, the shape of the signals transmitted and received shall be explained. The signal transmitted in base band is written as:

$${s}_{a} ( t ) = {\sum }_{i}^{} {\sum }_{j = 0}^{N - 1} {c}_{2} ( j ) p ( t - {jT}_{c} - {iNT}_{c} )$$

where p(t) is the shape of the, pulse (“chip”), Tc the duration of this pulse, Ca(j) is the access code for example with a length N, with j=0, 1, . . . , N−1.

The signal received in the input E is made up by one or several access codes of the same nature. The radio-electric channel, if necessary, introduces a phase-shift, a Doppler effect (hardly dealt with here), some multiple routes (not dealt with here), some delays, . . . The input signal is written (disregarding the components due to the traffic and the noise) as follows:

$$r ( t ) = {\sum }_{a = 1}^{Ka} {s}_{a} ( t - {τ}_{a} ) {ⅇ}^{{jω}_{a} ( t )} avec {s}_{a} ( t ) = {\sum }_{j = 0}^{{N}_{a} - 1} {c}_{a \cdot j} p ( t - jTc )$$

where Ka is the access code number used and Na is the length of the access codes. The delays •ₐ are assumed to be constant, the variation of •ₐ over time is assumed to be low before Ts. The acquisition time is large before Ts in such a way that the variations of Ka are slow before Ts.

In the digital systems, the signal received is sampled and digitised at a rate of 1/Te multiple of the frequency 1/Te, i.e., Te=TC/e. e=1 may be chosen,

which goes back to only considering one single sample per pulse. The invention is applied whatever the value of E is, but the mathematical formula is less time-consuming with the hypothesis E=1, which shall be kept henceforth.

The filter 10 adapted to the access code is classically a finite impulse response filter (FIRF) from an impulse filter:

$$\begin{matrix}{h}_{mf} ( t ) = {\sum }_{j = 0}^{N - t} {c}_{a} ( j ) δ ( t - {jT}_{c} ) or , in digital , with E = 1 \text{:} \\ {h}_{mf} ( n ) = {\sum }_{j = 0}^{N - 1} {c}_{a} ( j ) δ ( n - j ) .\end{matrix}$$

The adapted signal after filtering is written as:

C(t)=r(t)*h_{mf}(t)

The combined delayed multiplication performed by the circuit 12 performs the non-linear operation on signal C:

D(t)=C(t)xC*(t−Ts) or, in digital, with E=1:

D(n)=C(n)xC*(n−N)

The information searched for may, in certain cases, be found in the real part of the signal (property of the non-modulated code). It is the role of the circuit 14 to deliver this real part:

E(t)=Re(D(t)) or, in digital, E(n)=Re(D(n)).

The filter 16 may be made up by a battery of low-pass digital filters, which combine the samples away from a symbol period. Its transfer function in z may, for example, be:

$${H}_{lpf} ( z ) = \frac{1}{t - {cz}^{- N}} .$$

The filtered signal is then:

F(n)=E(n)*h_{lpf}(n)

The threshold detector 18a compares the signal F(n) with a predefined threshold S and counts the number of overshoots of this threshold in the consecutive windows with a duration Ts. It will be seen that if the number of samples taken per impulse is greater than 1 (E>1), it is only necessary to count a single overshoot per chip period. An overshoot is therefore validated if, for example:

F(n)>S and F(n)>F(n−1)

F(n)>F(n+1)

FIG. 3 shows another mode for producing the means for detecting the access codes. The circuit depicted includes:

a general input E,

a battery of N correlators 20₁, . . . , 20_{N} adapted to the access code searched for and with one spread with respect to the other over a duration equal to the duration Tc of an impulse from the sequences forming the access codes,

connected to the output from each correlator:

a means 12₁, . . . , 12_{N} to perform a combined delayed multiplication,

a circuit 14₁, . . . , 14_{N} to extract the real component (or part) of the signal delivered by the preceding means (still in the case in which only the real component is processed),

a digital filter 16₁, . . . , 16_{N} preferentially a low-pass filter,

a means 18a linked to all the digital filters and suitable for detecting the overshoot, by the filtered signal, of a predetermined threshold or calculated as and when in an adaptive manner (automatic) and a means 18b for counting the numbers of overshoots in a time window with a duration equal to the duration Ts of the data symbols transmitted.

The signal (Fn) may have a speed such as the one shown in FIG. 4. The sampling range n appears on the X-axis (assumed to range from 0 to 512). In the example taken N=32, E=8, Ts=NxE+256. The Y-axis is the range for F(n) in an arbitrary unit. S designates the threshold. The time solution interval, which corresponds to the width of the peaks, is around 8 samples. If the number of access peaks needs to be known, therefore it is not necessary to just count the number of overshoots of the threshold S, but rather to apply a rule taking into account the amplitude of this interval.

Thus two peaks CA1 and CA2 may be seen, on FIG. 4, in each window, corresponding to the detection of the two access codes.

The main peak detector 18 on FIGS. 2 and 3 searches for the peak or peaks with the greatest width in a window for duration Ts and sends back the pertinent value nₘₐₓ.

This value indicates the displacement between the access and a fixed reference for the clock symbol upon reception.

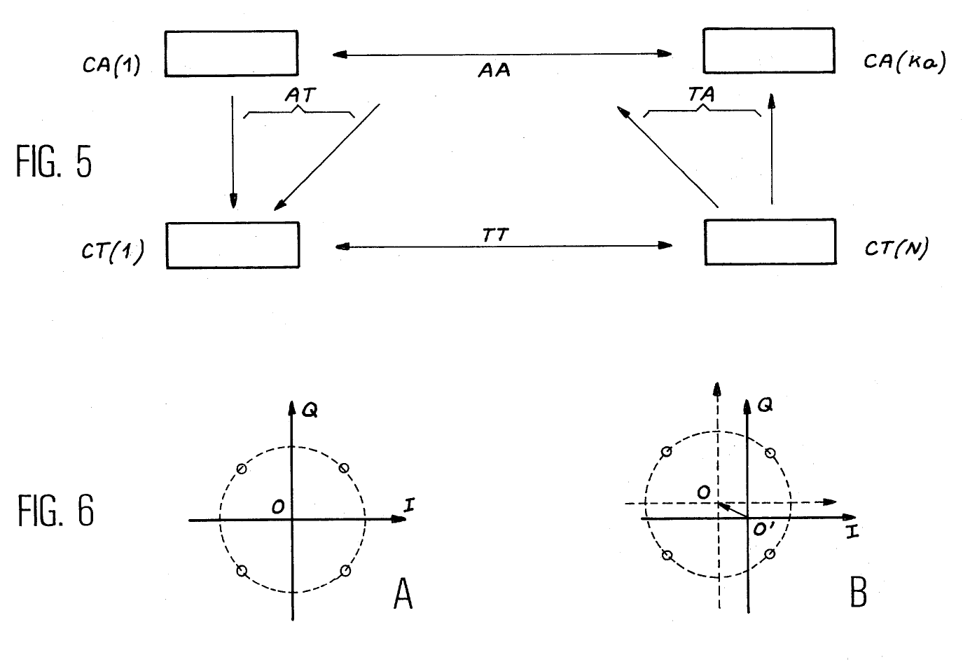

The use of access codes disturbs the transmission of the information by a mechanism called Multiple Access Interference (MAI, in its abbreviated form). FIG. 5 illustrates the source of this phenomenon. The codes are shown in the latter symbolically by rectangles CA(1), . . . , CA(Ka) for Ka access codes and CT(1), . . . , CT(N) for N traffic codes. The Multiple Access Interference between traffic codes, noted down as TT (“traffic-traffic”), is the classic interference which may be removed using different well-known techniques (orthogonality of the codes, serial or parallel removal of the interferences, etc . . . ). The interferences between access codes, noted down as AA (Access-Access) is marginal and in any case does not affect the data traffic. The interferences between access codes and traffic code (AT) or between traffic codes and access codes (TA) are more difficult to deal with because a priori nothing is known about the access codes, although the correction must be performed “blindfolded”. Since TT interferences are generally well compensated, the system performance levels(that is to say the traffic quality) risk being limited by the AT interferences, if they are not reduced as well.

The effect of this interference is illustrated in FIG. 6. It is assumed, in this example, that the modulation used when transmitting is a modulation of the Quaternary Phase Shift Keying (QPSK) type. In a diagram in which the I component in phase with the carrier is shown on the X-axis and the Q component in quaternary phase with this carrier is shown on the Y-axis, the four possible phases are shown by a constellation of four points spread around a circle centred over the source 0 (part A in FIG. 6). The presence of the access codes is translated by an offset of the constellation as illustrated in part B where it may be seen that the fours points are spread over a circle which is no longer centred at the intersection 0′ of the I and Q axes. The correction will consists of bringing 0 to 0′ (this correction is symbolised by the arrow).

In order to clarify this point, a mathematical formula will be given for the digital signal received (with the hypothesis of E=1). This signal (without the noise) may be written as follows:

$$\begin{matrix}r ( n ) = {\sum }_{a = 1}^{Ka} {A}_{a} {\sum }_{j = 0}^{{N}_{a} - 1} {c}_{a} {,}_{Na - 1 - j} δ ( n - j - {τ}_{a} ) {ⅇ}^{{jϕ}_{a} ( n )} + \\ {\sum }_{k = 1}^{K} {A}_{k} {d}_{k , n = N - 1} {\sum }_{j = 0}^{N - 1} {c}_{k} {,}_{N - 1 - j} δ ( n - j ) {ⅇ}^{{jϕ}_{k} ( n )}\end{matrix}$$

In this expression, the term on the left represents Ka asynchronous accesses (with a delay •ₐ) performed with codes with a length Na and the term of the right K represents synchronous traffic codes carrying the data dk. Since the system is synchronous, care will be taken to choose orthogonal codes, in such a way as to have a null TT component. It will be assumed that •ₖ(n) and •ₐ(n) are constant. The correlated signal with traffic code number 1 is written as:

$$\begin{matrix}C ( N - 1 ) = {\sum }_{a = 1}^{Ka} {A}_{a} {\sum }_{j = 0}^{Na - 1} {\sum }_{j = 0}^{N - 1} {c}_{1 , N - 1 - j} {c}_{a , Na - 1 - j - {τ}_{a}} {ⅇ}^{{jϕ}_{a}} + \\ {\sum }_{k = 1}^{K} {A}_{k} {d}_{k , n = N - 1} {\sum }_{j = 0}^{N - 1} {\sum }_{j = 0}^{N - 1} {c}_{1 , N - 1 , j} {ⅇ}^{{jϕ}_{k}}\end{matrix}$$

The chosen traffic codes are orthogonal, as in any synchronous CDMA system. Thus, the term on the right only contains the user's contribution, and the term on the left does not depend on the instant considered, because the access codes do not carry any data liable to change all the N impulses:

$$C ( N - 1 ) = {\sum }_{a = 1}^{Ka} {A}_{a} {c}_{1 , a , τ a} {ⅇ}^{{jϕ}_{a}} + {A}_{1} {d}_{1 , n = N - 1} ( {ⅇ}^{{jϕ}_{1}} )$$

The term on the right contains the data. This is the one that gives its shape to the constellation. The term on the left represents the offset that is expected to be removed. It is formed by the sum of small offsets Ka linked to each access.

Thus, each access introduces a slowly variable offset (according to the hypotheses formulated above), which depends on all the parameters Aₐ, Kₐ, {cₐ(j),ₐ and the traffic codes.

It will be noted that the greater Ka is, the more the sum of the elementary offsets is slowly variable, since the total number of parameters rises and that the effect of time averaging is great. The solution proposed by the invention will therefore work just as well in this context (the filter has a quality ‘of adaptation’ to the variation in the signal).

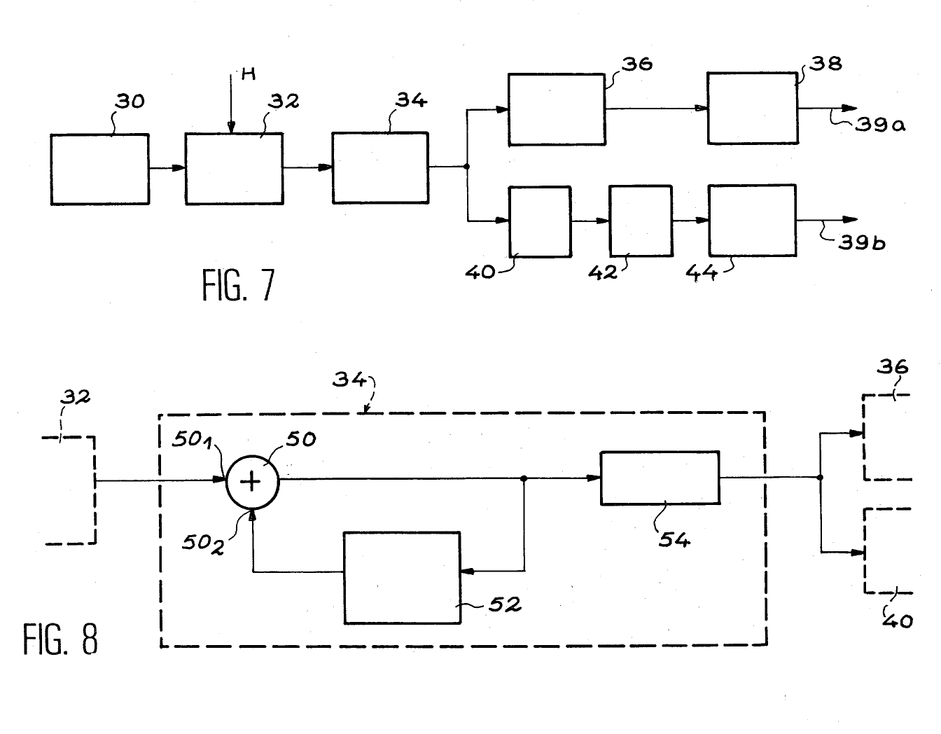

The removal of a continuous component in a digital signal is a classic problem, which does not necessarily find a satisfactory solution in terms of performance. In this respect, reference may be made to the article entitled “Low Complexity Digital DC-Offset Compensation in Cellular/PCs Mobile Communication Systems” by I. Held, R. Mayer, A. Chen, J. Huber, published in the Proceedings of PIMRC'99, Sep. 13-15, 1999. pp. 459-463. This article proposes two techniques: the first is a temporary averaging performed with the aid of a finite impulse response (FIR) filter; the second one is a regression in the sense of the least squares. In the present invention, t a third technique is proposed for implementing a filter with an infinite impulse response (IIR). This filter is placed at the output of the correlators processing the traffic codes, as illustrated in FIG. 7. In this Figure, the breakdown of the circuits is not given because these circuits for processing the traffic codes are classic ones. Generally speaking, these means include a filter 30 adapted to the shape of the sequence impulses, a correlator 32 adapted to the traffic code that is expected to be processed and demodulated, an access codes rejection filter 34, in the high point of the path a square law detector 35 and a power estimator 38, in the low point of the path a phase recovery loop (coherent demodulation) 40 followed by a decision-making body 42 and possibly a differential decoder 44.

It is important to point out that:

the rejection filter 24, when it is placed before the phase loop 40, sees a constellation that “turns” over time (because the phase depends on the time *k); but the circle that it describes always has the same centre corresponding to the offset that is expected to be removed; therefore that does not have any influence on the performance of the processing;

the rejection filter 34 may be placed after the phase loop 40; but the continuous component may have some disastrous effects on the phase loop;

the rejection filter 34 may be built into the phase loop filter 40.

In the case of the non-coherent demodulation, the delayed multiplication is greatly affected by the offset, the rejection filter is all the more useful; the power estimate 38 is greatly affected by the offset, since the estimate will be biased through the power of the parasite continuous component; the rejection filter is therefore, there again, highly useful.

The filter allowing the interferences due to the accesses to be cut down may be a high-pass, digital filter of the order 1 whose transfer function is:

$$H ( z ) = \frac{( \frac{c - 1}{c} ) ( 1 - {z}^{- 1} )}{1 - ( \frac{c - 1}{c} ) {z}^{- i}} with c ⪢ 1$$

which may be written as:

$$\frac{{Kz}^{- 1}}{1 - ( 1 - K ) {z}^{- 1}} + \frac{( 1 - K )}{1 - ( 1 - K ) {z}^{- 1}} ; with K = 1 / c .$$

One example of a possible filter is given in FIG. 8. This filter includes an adder 50 with two inputs 501, 502, a gain amplifier 52:

$$\frac{{Kz}^{- 1}}{1 ( 1 - K ) {z}^{- 1}}$$

with this amplifier's output being looped back onto the input 502 of the adder 50, and a gain amplifier 54 (1−K).

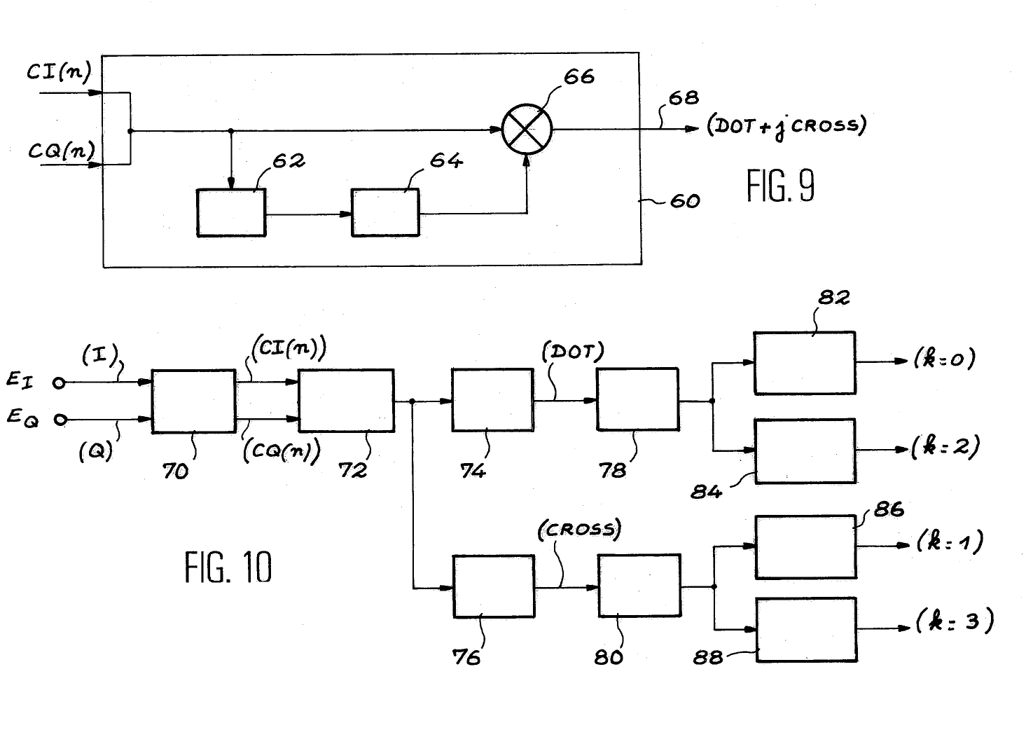

In the preceding description, it has been assumed that only the real component (or real part) was processed from the signal delivered by the suitable means for performing a delayed multiplication (this was the role of the means 14 in FIG. 2 or the means in 14₁, . . . , 14_{N} in FIG. 3 for extracting this real component). But the invention is more general and covers the case in which both the real and the imaginary components are processed. This mode for implementation is advantageous when, at the time of the transmission, a “Quaternary Phase Shift Keying” modulation abbreviated as QPSK, is used, a modulation that may also be used for the access codes. In other terms, rather than modulating the access codes through series of symbols that are all identical, they may be modulated by some series of distant symbols in a phase of 900 and therefore occupying, successively, the four points of a constellation diagram. The successive phases are then equal to k.90°, where k takes the values 0, 1, 2 or 3. FIGS. 9 and 10 illustrate this mode for implementation.

FIG. 9, first of all illustrates an example for the implementation of a combined, delayed multiplication circuit. It involves a non-linear digital operator for non-coherent phase demodulation. This referenced circuit 60 receives two correlation signals, noted respectively as CI(n) and CQ(n), where I is related to the component in phase with the carrier and Q to the quadrature, and where n represents the sampling range. The complex signal CI(n)+jCQ(n) is applied to a circuit 61 which performs an operation for combining and therefore delivers the signal CI(n)+jCQ(n). This signal is applied to a multiplier 66 which receives, moreover, the input signal. Then a complex signal is obtained on the output 68 which is noted down as DOT+jCROSS(n) with:

DOT=CI(n−NE)CI(n)+CQ(n−NE)CQ(n)

CROSS=CI(n−NE(CQ(n)+CI(n)CQ(n−NE)

If the access code is modulated by a series of symbols that are distant by k.90° from symbol to symbol on the constellation diagram, then the signal at the output of the combined, delayed multiplication means will show a peak (possibly hidden in the noise), which will be:

positive o the real component DOT if k=0 and negative on this same component if k=2,

positive on the imaginary component CROSS if k=1 and negative on this same component if k=3.

So four different kinds of access may be defined by choosing in the appropriate manner the series of symbols for modulating the acquisition code. In the receiver, four different tests shall therefore be implemented like the one that is illustrated in FIG. 10. The means represented on this Figure include:

a filter 70 adapted to the access code and receiving on two inputs EI, EQ the two components in phase (I) and in phase quadrature (Q),

a combined, delayed multiplication circuit 72 (analogous to the circuit 60 in FIG. 9),

an extraction circuit 74 for the real component from the signal delivered by the circuit 72, that is to say DOT.

an extraction circuit 76 in parallel for the imaginary component from the signal delivered by the circuit 72, that is to say CROSS,

two digital filtering circuits 78, 80 for reducing the noise,

one detection circuit 82 and counter for positive peaks on a symbol duration and receiving the real filtered component DOT,

one detection circuit 84 and counter for negative peaks on a symbol duration and with this one also receiving the real filtered component DOT,

one detection circuit 86 and counter for positive peaks on a symbol duration and receiving the imaginary filtered component CROSS,

finally, one detection circuit 89 and counter for negative peaks on a symbol duration and with the latter also receiving the imaginary filtered component CROSS.

These last four means correspond to the four possible values for k in the following order:

circuit 82: access k=0

circuit 84: access k=2

circuit 86: access k=1

circuit 89: access k=3

If FIG. 10 is compared to FIG. 2 where only the real component with a single threshold was processed, it may be seen that the tests have been quadrupled: two are now performed on the real part and two on the imaginary part.

Naturally, an intermediate solution may be suffice with, for example, a processing on the single signal DOT, with k=0 or k=2. There will no longer be any need therefore for anything but a single digital filter (in fact the filter 78), which is a noticeable simplification because this kind of filter is complex.

1. A CDMA, Code Division Multiple Access, type radio-communications procedure in which:
codes called traffic codes (CT(1), . . . , CT(N)) are used, formed by sequences of impulses having a certain rate, with these codes belonging to the different users in the system; these codes are modulated by the information that each user must transmit and the modulated codes are transmitted,
the signal corresponding to all the signals transmitted is received, a correlation is performed adapted to the different codes, the correlation signal is demodulated and the information transmitted is recovered,
with this procedure being characterised by the fact that, in order to allow a new user to use the procedure:
a predetermined specific code is transmitted, called an access code (Ca, (j)), belonging to this new user, with this code being formed by a sequence of impulses having the same rate as the sequences of the traffic codes, with this access code being modulated by a particular series of symbols,
the possible presence of these predetermined access codes is scanned for in the signal received and, in the event of the presence of such a code, the user is identified and he is authorised to communicate.

2. Procedure according to claim 1, in which:
when transmitting, the modulation for the data transfer is Quaternary Phase Shift Keying (QPSK), with the modulated signal having two components (I, Q), of which one (I) is in phase with a carrier and the other (Q) is in quadrature phase with the carrier,
upon reception, the correlation is performed on two components (I, Q), respectively, in phase and in quadrature phase and two corresponding correlation signals are produced (CI(n), CQ(n)).

3. Procedure according to claim 2, in which:
when transmitting, the access codes are modulated by a series of symbols whose phases are spread out between one another by k.90°, where k is equal to 0, 1, 2 or 3,
upon reception, in order to search for the presence of an access code, a combined delayed multiplication is carried out on two correlation signals (CI(n), CQ(n))in order to obtain a complex signal having one real component (DOT) and one imaginary component (CROSS), and the presence of a positive or negative peak is searched for, over a duration equal to the duration of a symbol, in at least one of the real and imaginary components.

4. Procedure according to claim 1, in which the access code is modulated by a series of symbols which are all identical.

5. Procedure according to claim 1, in which each correlation signal corresponding to a traffic code is corrected in order to take into account the interference between this traffic code and the set of access codes present.

6. Procedure according to claim 5, in which the correction is performed by removing the continuous component present in the signal to be demodulated.

7. Procedure according to claim 6, in which the correction is performed by high-pass filtering.

8. Radio-communications receiver of the CDMA, Code Division Multiple Access, type for implementing the procedure according to claim 1, with this receiver including:
some appropriate means for receiving a signal transmitted and to deliver a correlation signal adapted to the different traffic codes,
some means for demodulation,
some means for the restoration of the information transmitted,
with this receiver being characterised by the fact that it also includes some appropriate means for detecting the presence, in the signal received, of certain access codes having the same
rate as the sequences of traffic codes and having been modulated by a specific series of symbols.

9. Receiver according to claim 8, in which the appropriate means for detecting the presence, in the signal received, of access codes will include:
a filter (10) adapted to the access code,
a means (12, 60) for performing a combined delayed multiplication,
a circuit (14, 74, 78) for extracting the real component and/or the imaginary component of the signal delivered by the previous means,
a filter (16, 76, 80),
some means (18a, 18b) for detecting the overshoots of a predetermined threshold by the filtered signal, and to position these overshoots and to synchronise them in a time window with a duration equal to the duration of the data symbols transmitted.

10. Receiver according to claim 8, in which the appropriate means for detecting the presence in the signal received of access codes will include, for each access code liable to be present:
a battery of N correlators (20₁, . . . , 20_{N}) adapted to the access code searched for and with one spread with respect to the other over a duration equal to the duration of an impulse from the sequences forming the access codes,
connected to the output from each correlator:
a means (12₁, . . . , 12_{N}) to perform a combined delayed multiplication,
a circuit (14₁, . . . , 14_{N}) to extract the real component and/or the imaginary component of the signal delivered by the preceding means,
a filter (16₁, . . . , 16_{N}),
a means (18a, 18b) linked to all the digital filters and suitable for detecting the overshoots, by the filtered signal, of a predetermined threshold and in order to position these overshoots and to synchronise them in a time window with a duration equal to the duration (Ts) of the data symbols transmitted.

11. Receiver according claims 9 or 10, in which the means (12, 72) for performing combined multiplication processes a signal with two components (VI(n)), CQ(n) and delivers a signal that has a real component (DOT) and an imaginary component (CROSS), with the means for overshoot detection including, for the real component (DOT), some means (82, 84) for the detection of positive and negative threshold overshoots respectively and, for the imaginary component (CROSS), some means (86, 88) for detecting positive and negative threshold overshoots, respectively.
